(19) United States
(12) Patent Application Publication
(10) Pub. No.: US 2018/0238043 A1
(43) Pub. Date: Aug. 23, 2018

(54) BUILDING HAVING TENSILE STRUCTURE

(71) Applicant: Komoro Nunobiki Strawberry Farm Co., Ltd., Komoro-shi, Nagano (JP)

(72) Inventor: Tsuyoshi Kuramoto, Komoro-shi, Nagano (JP)

(73) Assignee: Komoro Nunobiki Strawberry Farm Co., Ltd., Komoro-shi, Nagano (JP)

(21) Appl. No.: 15/753,465

(22) PCT Filed: Aug. 19, 2016
(86) PCT No.: PCT/JP2016/074236

§ 371 Date: Feb. 19, 2018

(30) Foreign Application Priority Data
Aug. 20, 2015 (JP) 2015-163189

(51) Int. Cl. E04B 1/34; E04B 1/342; E04B 1/24; E04B 7/02; E04D 5/08; E04F 13/00; E04D 13/04; E04H 5/08; A01G 9/22

(52) U.S. Cl. CPC E04B 1/34; E04B 1/342; E04B 1/24; E04B 7/022; E04D 2013/0454; E04F 13/002; E04D 13/0445; E04H 5/08; A01G 9/227; E04D 5/08

(57) ABSTRACT

A greenhouse building has perimeter wall frames constituted by linear materials such as single pipes, and roof frames constituted by tension wires that are extended in a stretched state in the longitudinal and crosswise directions. The tension force of the tension wires is received by the installation surface through anchoring tension wires. Only compression force acts on support posts of the wall frames and substantially no bending force acts thereon. A large building can be easily constructed using linear materials such as single pipes with a small diameter. A large greenhouse with high light receiving efficiency can be easily constructed without using heavy building materials such as steel frame materials.

### TECHNICAL FIELD

The present invention relates to a building having a tensile structure in which the structural body of the building is constructed using a tensile structure, and particularly relates to a building having a tensile structure used as: a greenhouse for, inter alia, cultivating vegetables, fruits, and the like, cultivating other plants; various warehouses; temporary buildings installed in various event venues and the like; etc.

### BACKGROUND ART

Rigid frames configured by welding or bolting steel columns and beams are commonly used as, e.g., large greenhouse buildings. Additionally, truss structures and the like, combined by steel frame materials, are often used as roof structures. Such buildings having rigid structures are disclosed in Patent Documents 1, 2, and 3.

### PRIOR ART LITERATURE

### Patent Documents

### Patent Document 1: JP-A 09-25683

### Patent Document 2: JP-A 2000-324956

### Patent Document 3: WO 2004/064496

### SUMMARY OF THE INVENTION

### Problems to be Solved by the Invention

Greenhouse buildings, warehouses, temporary buildings, and other structures require various types of members and components in accordance with, inter alia, the loads acting on different parts, in order for the walls and roofs to be constructed. In the case of larger buildings, the structural materials of the posts, beams, etc., used must have greater cross-sectional dimensions, and the number of structural materials must be increased. Because of this, for example, construction costs escalate for greenhouses required for large-scale cultivation, and recovering the increased initial investment expenditure takes time. Additionally, in the event of expansion, the strength of the entire building must be recalculated, there are cases in which the existing building must be redesigned, and the expansion incurs labor and costs.

Furthermore, when a greenhouse building has been enlarged, the structural materials that are employed have larger dimensions, and the structural materials occupying wall surfaces and a roof surface increase in area. As a result, the opening ratio of the wall surfaces and roof surface decreases, and lighting efficiency decreases accordingly.

An object of the present invention is to provide a building having a tensile structure that can be constructed inexpensively and can be more readily expanded and dismantled.

Another object of the present invention is to provide a building having a tensile structure suitable for use as a greenhouse building or the like that can be constructed inexpensively and can be more readily expanded and dismantled, and in which sufficient lighting efficiency can be maintained.

### Means for Solving the Above Problems

A building having a tensile structure of the present invention is characterized by comprising:

front and back gable-side wall frames configured from gable-side support posts erected on an installation surface at predetermined intervals in a crosswise direction, rafters joining upper ends of the gable-side support posts together, and gable-side lateral members extended horizontally over the gable-side support posts;

left and right flat-side wall frames configured from flat-side support posts erected on the installation surface at predetermined intervals in a longitudinal direction, and flat-side lateral members extended horizontally between upper ends of the flat-side support posts;

a middle frame located between the left and right flat-side wall frames and configured from middle support posts erected on the installation surface at predetermined intervals in the longitudinal direction, and a ridge member extended horizontally over upper ends of the middle support posts;

a roof surface configured from roof-surface longitudinal-directional tension members spread in a taut state at predetermined intervals in the crosswise direction between upper ends of the front and back gable-side wall frames, and roof-surface crosswise-directional tension members spread in a taut state through the ridge member at predetermined intervals in the longitudinal direction between upper ends of the left and right flat-side wall frames;

a ceiling surface configured from ceiling-surface longitudinal-directional tension members spread in a taut state at predetermined intervals in the crosswise direction between the upper ends of the front and back gable-side wall frames, and ceiling-surface crosswise-directional tension members spread in a taut state at predetermined intervals in the longitudinal direction between the upper ends of the left and right flat-side wall frames;

gable-side anchoring tension members spread in a taut state at predetermined intervals in the crosswise direction between the installation surface and the upper ends of the front and back gable-side wall frames; and

flat-side anchoring tension members spread in a taut state at predetermined intervals in the longitudinal direction between the installation surface and the upper ends of the left and right flat-side wall frames.

In the building having a tensile structure of the present invention, roof-surface crosswise-directional tension members and ceiling-surface crosswise-directional tension members are extended in a stretched state between the upper ends of the left and right flat-side wall frames through the ridge member, and the tension force of these tension members is borne by the installation surface via the left and right flat-side anchoring tension members. These tension members are supported at a predetermined height position from the installation surface by the support posts of the left and right flat-side wall frames and the middle frame. The support posts supporting the tension members are subjected to compression force in the axial direction of the posts, and substantially not subjected to a bending moment.

Similarly, the roof-surface longitudinal-directional tension members and the ceiling-surface longitudinal-directional tension members are extended in a stretched state between the upper ends of the front and back gable-side wall frames, and the tension force of these tension members is borne by the installation surface via the front and back gable-side anchoring tension members. These tension members are supported at a predetermined height position from the installation surface by the support posts of the front and back gable-side wall frames. The support posts supporting the tension members are subjected to compression force in the axial direction of the posts, and substantially not subjected to a bending moment.

Roof frames are configured from longitudinal-directional and crosswise-directional tension members extended in a taut state along the roof surface and the ceiling surface. Therefore, a roof having a large area can be constructed without providing support posts etc. inside the building.

Because the support posts are subjected to compression force in the axial direction and are not substantially subjected to a bending moment, the support posts can be made of single pipes or other inexpensive members. Additionally, the support posts used in the portions of the building can be members having the same cross-section. Two or more support posts are preferably used in regions subjected to a large compression load and regions where long support posts are needed.

The construction work first involves performing foundation work for installing foundations for attaching the gable-side anchoring tension members and the flat-side anchoring tension members, and foundations for installing the support posts. Next, the support posts and lateral members, which are straight linear members, are brought together using clamp tools to construct the frames. After the frames have been installed, tension members are extended in the longitudinal and crosswise directions and linked to the gable-side anchoring tension members and flat-side anchoring tension members, and the tension members come to be extended in a predetermined taut state.

There is no need for, inter alia, construction of foundations having high proof strength, or for rigid joints of iron frame members using welding, connecting bolts, or the like; there is also no need for heavy iron frame pillars, iron frame beams, or other construction materials. Additionally, the installation surface is not limited to a horizontal flat surface and may be a sloping ground or an uneven ground surface. Therefore, the construction work can be performed in an inexpensive and simple manner.

Other than the middle ridge member, the front and back rafters, and the left and right flat-side lateral members, the roof frame includes nothing more than tension members extended at predetermined intervals longitudinally and crosswise, and the roof frame has a large opening ratio of the roof surface. The support posts and lateral members constituting the gable-side wall frames and flat-side wall frames are linear members having a small cross-section, and the opening ratio of the outer walls (gable-side walls, flat-side walls) of the building is therefore large. Consequently, the lighting efficiency of the entire building can be increased. According to the measurements of the inventors of the present invention, the lighting efficiency of a common large greenhouse is less than 70%, but in the case of a greenhouse building to which the present invention is applied, it is confirmed that lighting efficiency greater than 90% can be ensured.

In the present invention, metal or plastic tension wires (wire ropes, cables) can be used as the flat-side anchoring tension members and the gable-side anchoring tension members. In this case, the tension members can be configured from upper wires, lower pull-out wires pulled out from the installation surface, and tension adjustment members (e.g., turnbuckles) extended between the upper wires and the lower pull-out wires. The upper wires and/or the lower pull-out wires preferably include adjustment parts capable of adjusting the extending lengths of the wires. The necessary tension force can be reliably imparted to the tension members by, e.g., both operating the tension adjustment members such as the turnbuckles and adjusting the wire lengths.

When the building of the present invention is used as, e.g., a greenhouse building, translucent panels or translucent films are affixed to the gable-side wall frames, the flat-side wall frames, and the roof surface.

For example, when a flexible translucent film is used, the translucent film can be affixed to the roof surface in the following manner. Long film stoppers extending in the longitudinal direction or the crosswise direction are disposed at predetermined intervals along the roof surface, and a translucent film is disposed so as to cover the film stoppers from above. The film stoppers are provided with upward-opening film-stopping grooves extending in the length direction of the film stoppers, and parts of the translucent film are inserted into the film-stopping grooves from above and fixed so as to not come out of the film-stopping grooves.

The film stoppers can be extended between the ridge member and the upper ends of the gable-side wall frames at predetermined intervals along the roof surface. Specifically, the film stoppers can be extended in the crosswise direction along the roof slope. Water droplets adhering to the film stoppers flow down along the film stoppers. The water droplets adhering to the film stoppers can be prevented or inhibited from falling into the building.

In this case, tension-imparting members that impart a predetermined amount of tension to the film stoppers are disposed, and the film stoppers can be utilized as tension members. For example, turnbuckles are interposed between one end of each film stopper and the upper ends of the gable-side wall frames. The turnbuckles are operated to exert a predetermined amount of tension on the film stoppers.

When the film stoppers are disposed horizontally in the longitudinal direction along the roof surface, for example, the film stoppers are configured from upper film stoppers having an upward-opening groove cross-section and lower film stoppers having a downward-opening groove cross-section, the roof-surface longitudinal-directional tension members are disposed in the film-stopping groove of the lower film stoppers, the roof-surface crosswise-directional tension members are disposed between the upper film stoppers and the lower film stoppers, and the translucent film is inserted in and fixed to the film-stopping groove in the upper film stoppers.

Next, buildings having a tensile structure of the present invention can be conjoined in the crosswise direction into a multi-bay building. For example, in the case of a multi-bay building including two buildings, one first building and another second building together form a building having the above-described configuration, and a flat-side wall frame positioned between the first building and the second building is preferably a single shared flat-side wall frame. When a second building is added to an existing first building, it is sufficient merely to adjust the tension of the tension members between the two buildings without changing the first building. Consequently, buildings can be added in a simple manner.

In the case of a multi-bay building, a trough portion can be formed between the roof surfaces of the first and second buildings. A gutter is preferably disposed in the trough portions, the gutter having a predetermined drainage slope outward in the longitudinal direction from the middle of the longitudinal direction.

### BRIEF DESCRIPTION OF THE DRAWINGS

FIG. 1 is a descriptive drawing showing a three-bay greenhouse building to which the present invention is applied;

FIG. 2(a) is a descriptive drawing showing front gable-side wall frames of the greenhouse building, and FIG. 2(b) is a descriptive drawing showing a front gable-side anchoring tension wire;

FIG. 3(a) is a descriptive drawing showing a left flat-side wall frame, FIG. 3(b) is a descriptive drawing showing a middle partitioning frame, FIG. 3(c) is a descriptive drawing showing a right flat-side wall frames, and FIG. 3(d) is a descriptive drawing showing the positions thereof;

FIG. 4(a) is a descriptive drawing showing the aligned state of the tension wires defining the roof surface, and FIG. 4(b) is a descriptive drawing showing the aligned state of the tension wires defining the ceiling surface;

FIG. 5(a) is a descriptive drawing showing a trough portion between the roof surfaces of adjacent greenhouse buildings, as seen from the longitudinal direction, and FIG. 5(b) is a descriptive drawing showing the trough portion as seen from the crosswise direction;

FIG. 6 includes descriptive drawings showing the structure of a ceiling window portion disposed in the peak portion of a greenhouse building;

FIG. 7 is a descriptive drawing showing the attachment structure for a translucent film in the roof surface;

FIG. 8 includes descriptive drawings showing a specific example of an anchoring tension member;

FIG. 9 is a descriptive drawing showing another example of a roof surface;

FIG. 10 includes a partial plan view and a partial side view showing a peak portion of a roof surface; and

FIG. 11 includes descriptive drawings showing the upper end portion and lower end portion of a roof-surface film stopper.

### MODE FOR CARRYING OUT THE INVENTION

An embodiment of a building having a tensile structure to which the present invention is applied is described below with reference to the drawings. In the embodiments described below, the present invention is applied to a greenhouse building, but the present invention is not limited to a greenhouse building. The present invention can of course be applied to various buildings such as warehouses, temporary buildings installed in event venues, and the like. For example, when a warehouse or the like is constructed, light-shielding wall panels, ceiling panels, or the like are affixed to the wall surfaces, ceiling surface, etc.

### Overall Configuration

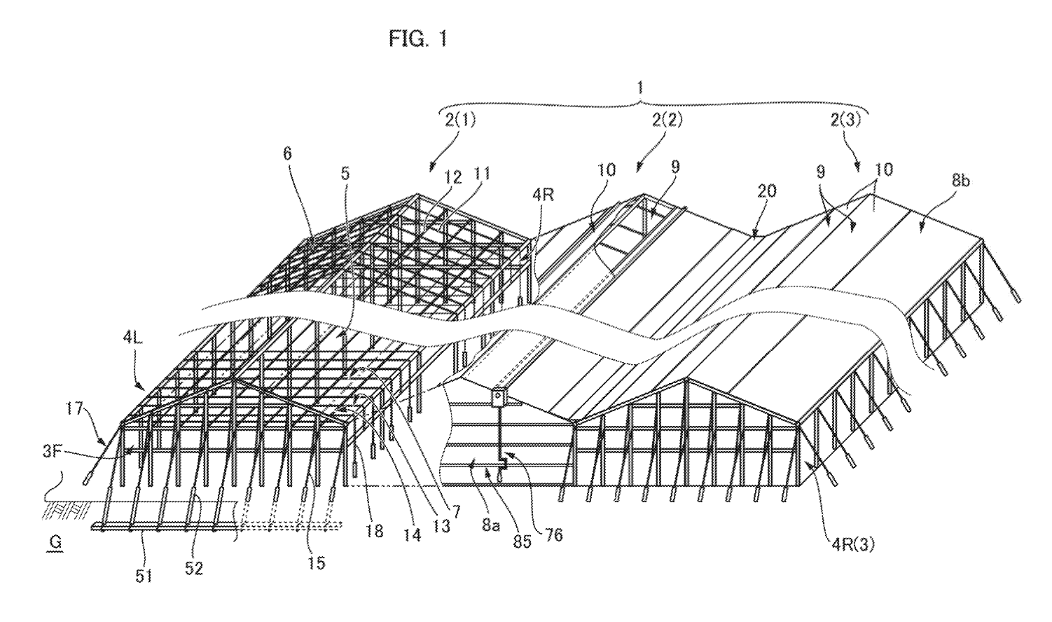

FIG. 1 shows a descriptive drawing of a three-bay greenhouse building for cultivating strawberries according to the present embodiment. The greenhouse building 1 is a connection in the crosswise direction of greenhouse buildings 2(1), 2(2), 2(3), each of which includes a rectangular gable roof of which the length of the gable side in the crosswise direction is 12 m and the length of the flat side in the longitudinal direction is 58 m, and each of which has a roof peak height of 4.5 m. In FIG. 1, part of the longitudinal direction is omitted. Additionally, exterior materials are omitted and only frames are shown for the left-side greenhouse building 2(1) and the right-side greenhouse building 2(3), and gable-side anchoring tension wires are omitted for the middle greenhouse building 2(2).

The greenhouse buildings 2(1)-2(3) basically have the same structure, and these buildings are therefore sometimes collectively referred to as the greenhouse building 2 The structural body of the greenhouse building 2 is basically configured using metal single pipes and high-tension, high-strength tension wires.

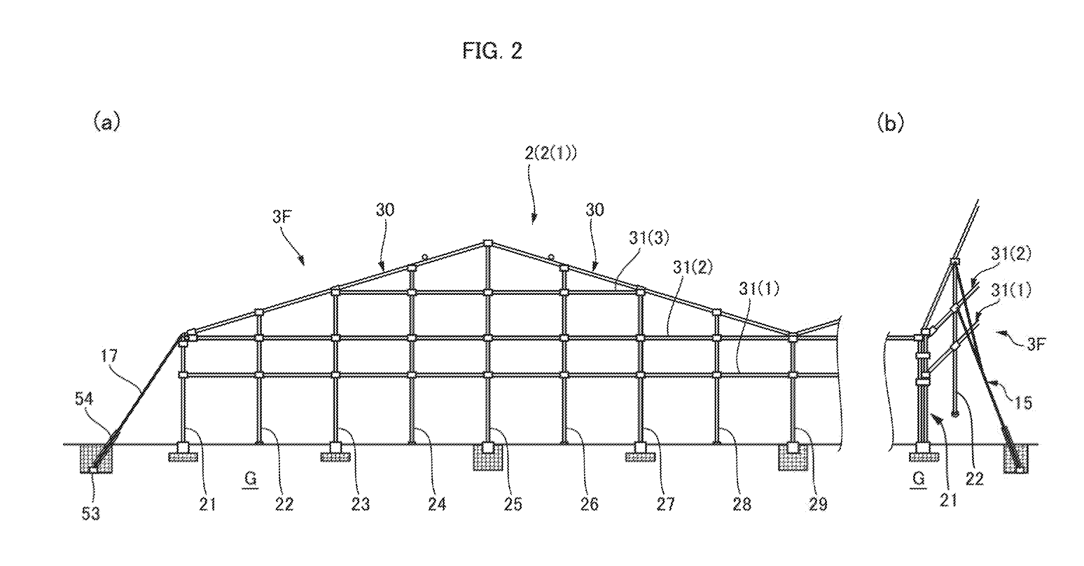

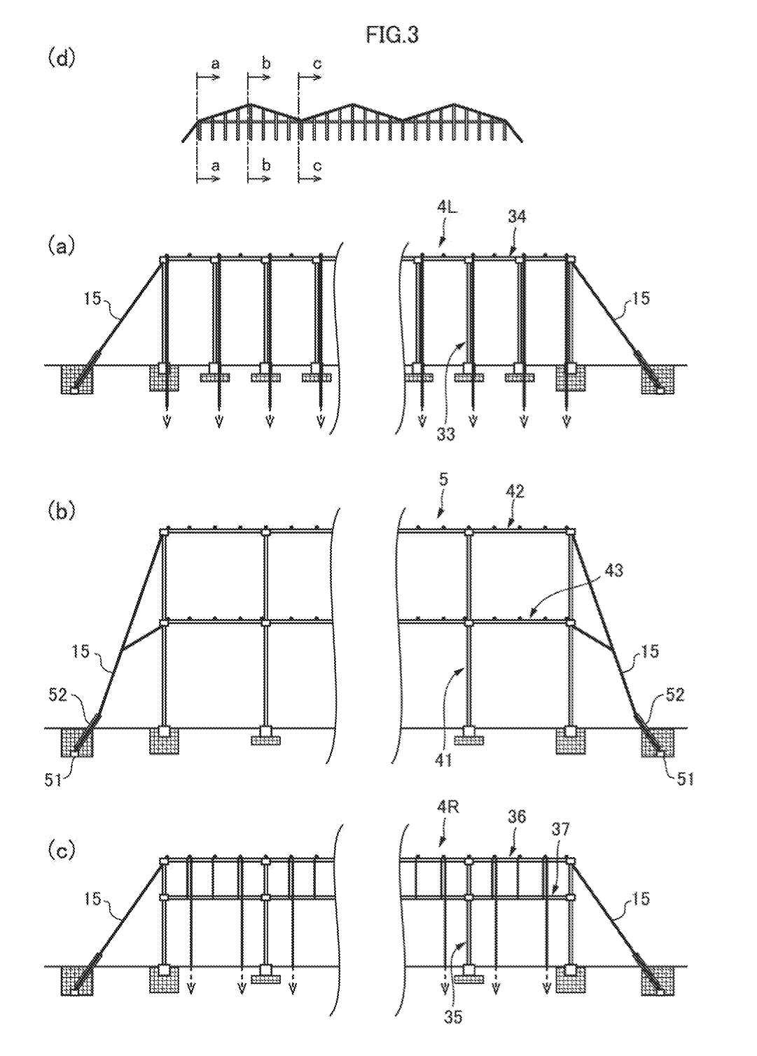

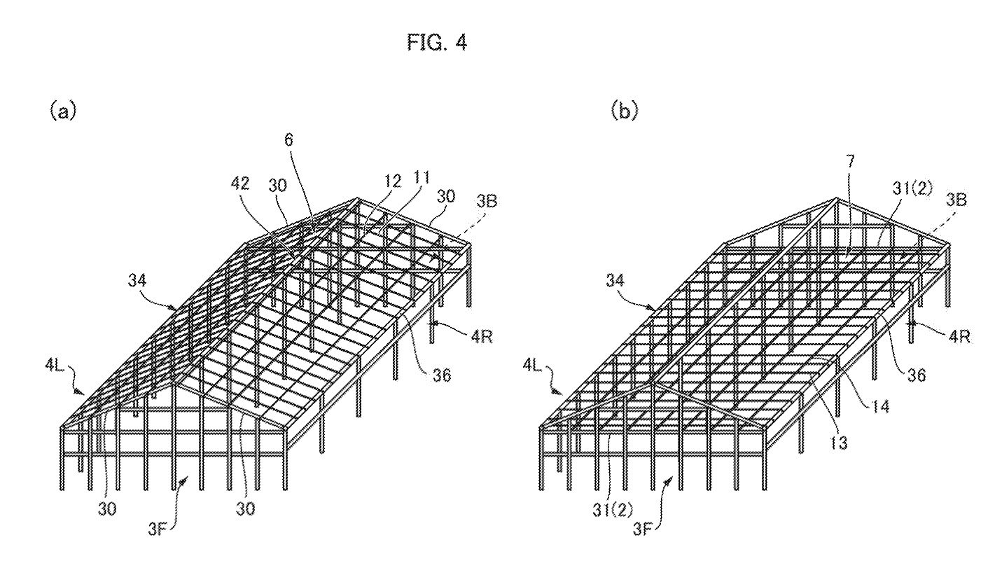

Specifically, the structural body includes: front and back gable-side wall frames 3F, 3B (see FIGS. 2 and 4) linked by various forms of single-pipe joints using single pipes having the same diameter as support posts, lateral members, etc.; left and right flat-side wall frames 4L, 4R (see FIGS. 3(a) and (c)); and a middle frame 5 (see FIG. 3(b)) extending in the longitudinal direction in a crosswise-directional middle position.

A roof surface 6 (see FIG. 4(a)) of the greenhouse building 2 and a ceiling surface 7 (see FIG. 4(b)) thereunder are formed by stretching tension wires 11-14 in the longitudinal direction and the crosswise direction at constant pitches, so that the wires are in a state of predetermined strain.

For example, stainless steel wires of high durability are used as the tension wires. Plastic wires composed of a polyester resin or the like can also be used. Instead of tension wires, for example, tension rebar or other steel tension materials used in reinforced concrete buildings, and other long metal tension materials, can also be used. The term “wires” is used with a wide meaning including wire materials referred to as ropes and cables.

The front and back gable-side wall frames 3F, 3B and the left and right flat-side wall frames 4L, 4R, over which the tension wires 11-14 are spread, are stretched to the outer sides in both the longitudinal direction and the crosswise direction by front and back gable-side anchoring tension wires (only front-side tension wires 15 are shown in the drawings), and by left and right flat-side anchoring tension wires 17, 18. These tension wires 15, 17, 18 are locked down to steel anchors 51 buried in the ground G, which is the installation surface.

A wall-surface translucent film 8a is affixed to the gable-side wall frames 3F, 3B and the flat-side wall frames 4L, 4R. A roof-surface translucent film 8b is affixed to the roof surface 6. These translucent films are composed of, e.g., a polyolefin resin or the like. Ventilating ceiling windows 9 extending in the longitudinal direction are formed with a constant width in the peak portion of the roof surface 6. The ceiling windows 9 can be opened by winding up ceiling window opening/closing films 10 covering the tops of the ceiling windows. The ceiling window opening/closing films 10 are translucent films composed of a polyolefin resin or the like. An insect screen (not shown) is pulled over the undersides of the ceiling window opening/closing films 10 so as to cover the ceiling windows 9.

Trough portions extending in the longitudinal direction are formed between the roofs 6 of adjacent greenhouse buildings 2. In these trough portions are formed gutters 20 extending in the longitudinal direction along the trough portions. The gutters 20 have a predetermined drainage slope outward in the longitudinal direction from the longitudinal-directional middle.

### Configurations of Component

### Gable-Side Wall Frames

FIG. 2(a) shows a descriptive drawing of the front gable-side wall frame 3F of the greenhouse building 1, and FIG. 2(b) is a partial perspective view of the same.

Referring to FIGS. 1 and 2, the front gable-side wall frame 3F includes a plurality (nine) of gable-side support posts 21-29, composed of single pipes standing vertically upright from the ground G in a row at fixed intervals, e.g., 1.5 m intervals in the crosswise direction. Left and right rafters 30 composed of single pipes are extended over the upper ends of the gable-side support posts 21-29, and three gable-side lateral members 31(1), 31(2), 31(3) are disposed horizontally at predetermined intervals. For example, these gable-side lateral members 31(1)-31(3) are disposed at height positions of 1.5 m, 2.5 m, and 3.5 m from the ground G, respectively.

The two lower gable-side lateral members 31(1), 31(2) are extended horizontally on the gable-side support posts 21-29, and the one upper gable-side lateral member 31(3) is extended horizontally between the gable-side support posts 23-27 at the same height position as the upper ends of the left and right gable-side support posts 23-27. These single pipe intersecting portions are linked by orthogonal joints, parallel joints, three-way joints, or another type of joints, as shown by the rectangular frames in the drawings. The gable-side support posts 21-29 are supported by independent footings buried in the ground G and having a predetermined proof strength. The rear gable-side wall frame 3B has a similar configuration. Various structures can be used for the footings, including independent footings, continuous footing, or the like. Additionally, film stoppers 85 are attached horizontally at predetermined vertical intervals to the outer surface of the gable-side wall frame 3F, and the wall-surface translucent film 8a is affixed so as to cover these film stoppers from the outer side.

### Flat-Side Wall Frame

FIG. 3(a) shows a descriptive drawing of the left flat-side wall frame 4L, FIG. 3(b) shows a descriptive drawing of the middle frame 5, and FIG. 3(c) shows a descriptive drawing of the right flat-side wall frame 4R. FIG. 3(d) shows a descriptive drawing of the positions of these frames.

The left flat-side wall frame 4L is configured from a plurality of flat-side support posts 33 of the same height, composed of single pipes standing vertically upright from the ground G in a row at fixed intervals, e.g., 1 m intervals in the longitudinal direction, and flat-side lateral members 34 composed of single pipes extending horizontally between the upper ends of these flat-side support posts 33, as shown in FIGS. 1 and 3 (a). Because the greenhouse building 1 of this example is a three-bay structure, the right flat-side wall frame 4R(3) of the rightmost greenhouse building 2(3) has the same structure as the flat-side wall frame 4L.

In the case of a multi-bay greenhouse building 1, the right flat-side wall frame 4R positioned between the left and right greenhouse buildings 2(1), 2(3) is configured from a plurality of flat-side support posts 35 of the same height composed of single pipes standing vertically upright from the ground G in a row at fixed intervals, e.g., 2 m intervals in the longitudinal direction, a flat-side lateral member 36 composed of a single pipe extended horizontally between the upper ends of the flat-side support posts 35, and a flat-side lateral member 37 extended horizontally between the flat-side support posts 35 at a height position between the flat-side lateral members 36 and the ground G, as shown in FIG. 3(c). Though not shown in the drawing, film stoppers 85 are horizontally attached at predetermined vertical intervals to the outer surfaces of the flat-side wall frames as well, and a wall-surface translucent film 8a is affixed so as to cover the outer sides of these film stoppers.

### Middle Frame

The middle frame 5, which is positioned between the left and right flat-side wall frames 4L, 4R, includes a plurality of middle support posts 41 composed of single pipes standing vertically upright from the ground G in a row at 2 m intervals in the longitudinal direction, as shown in FIG. 3(b). Two single-pipe support posts are disposed together with front and back gable-side support posts 25 at both longitudinal-directional ends. A ridge member 42 composed of a single pipe is extended horizontally over the upper ends of the middle support posts 41, defining the peak of the roof surface 6. Between the ridge member 42 and the ground G, at the same height position as the gable-side lateral member 31(2), is disposed a middle lateral member 43 composed of a single pipe extended horizontally on the middle support posts 41.

### Roof Surface

FIG. 4(a) shows a descriptive drawing of the aligned state of tension wires 11, 12 defining the roof surface 6, and FIG. 4(b) shows a descriptive drawing of the aligned state of tension wires 13, 14 defining the ceiling surface 7.

First, referring to FIGS. 1 and 4(a), the tension wires 11 are roof-surface crosswise-directional tension members, and are spread between the flat-side lateral members 34, 36 of the left and right flat-side wall frames 4L, 4R, at 50 cm intervals in the longitudinal direction, in a taut state across the ridge member 42 in the crosswise direction. The tension wires 12 are roof-surface longitudinal-directional tension members and are spread horizontally between the rafters 30 at the upper ends of the front and back gable-side wall frames 3F, 3B, at 1.5 m in the crosswise direction, in a taut state in the longitudinal direction.

### Ceiling Surface

The tension wires 13 defining the ceiling surface 7 are ceiling-surface crosswise-directional tension members and are spread horizontally between the flat-side lateral members 34, 36 at the upper ends of the left and right flat-side wall frames 4L, 4R, at 50 cm intervals in the longitudinal direction, in a taut state in the crosswise direction, as shown in FIGS. 1 and 4(b). Similarly, the tension wires 14 defining the ceiling surface 7 are ceiling-surface longitudinal-directional tension members and are spread horizontally between the gable-side lateral members 31(2) of the front and back gable-side wall frames 3F, 3B, at 1.5 m intervals in the crosswise direction, in a taut state in the longitudinal direction.

### Anchor Portions of Wires

Next, as is understood from FIGS. 1 and 2(b), the gable-side anchoring tension wires 15 are, excluding the wires on both sides, disposed at 1.5 m intervals in the crosswise direction, divided in two at the upper halves, and linked to the gable-side lateral members 31(2) and the upper ends of the gable-side support posts 21-29. The lower ends of the gable-side anchoring tension wires 15 are locked down to the long steel anchors 51 buried in the ground and extending horizontally in the crosswise direction. The buried portions of the gable-side anchoring tension wires 15 are covered up by protective vinyl chloride pipes 52.

The left flat-side anchoring tension wires 17 are disposed at 1 m intervals in the longitudinal direction, and the upper ends of these wires are linked to the flat-side lateral members 34 at the upper ends of the left flat-side wall frame 4L, as shown in FIG. 2(a). The lower ends of these wires are locked down to an anchor frame board 53 embedded in the ground and extending in the longitudinal direction. Additionally, the buried portions of the left flat-side anchoring tension wires 17 are also covered up by protective vinyl chloride pipes 54.

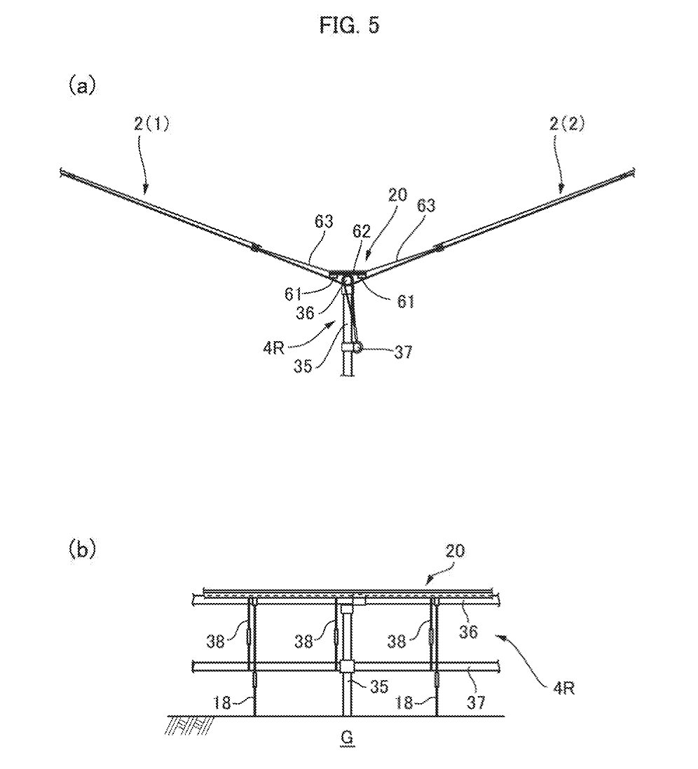

FIG. 5(a) shows a descriptive drawing of a trough portion between the roof surfaces 6, 6 of adjacent greenhouse buildings 2(1), 2(2), as seen from the longitudinal direction, and FIG. 5(b) shows a descriptive drawing of the same, as seen from the crosswise direction. The right flat-side wall frame 4R is a common flat-side wall frame, shared between the adjacent greenhouse buildings 2(1), 2(2), as shown in FIGS. 3(c) and 5. The flat-side anchoring tension wires 18 disposed in this frame are spread in a vertically taut state at 2 m intervals between the upper flat-side lateral member 36 and the anchoring steel material (not shown) buried in the ground, as shown in FIG. 3(c). Additionally, between the upper flat-side lateral member 36 and the lower flat-side lateral member 37, tension wires 38 are spread vertically in a taut state at 50 cm intervals.

### Gutters

The gutters 20, having a predetermined drainage slope, are disposed outward in the longitudinal direction from the longitudinal-directional middle, as shown in FIG. 5. The gutters 20 can be formed using, e.g., scaffold planks 62 disposed on plank members 61 extending in the longitudinal direction along the trough portions, collar steel planks 63 disposed on the scaffold planks 62, etc.

### Ceiling Windows

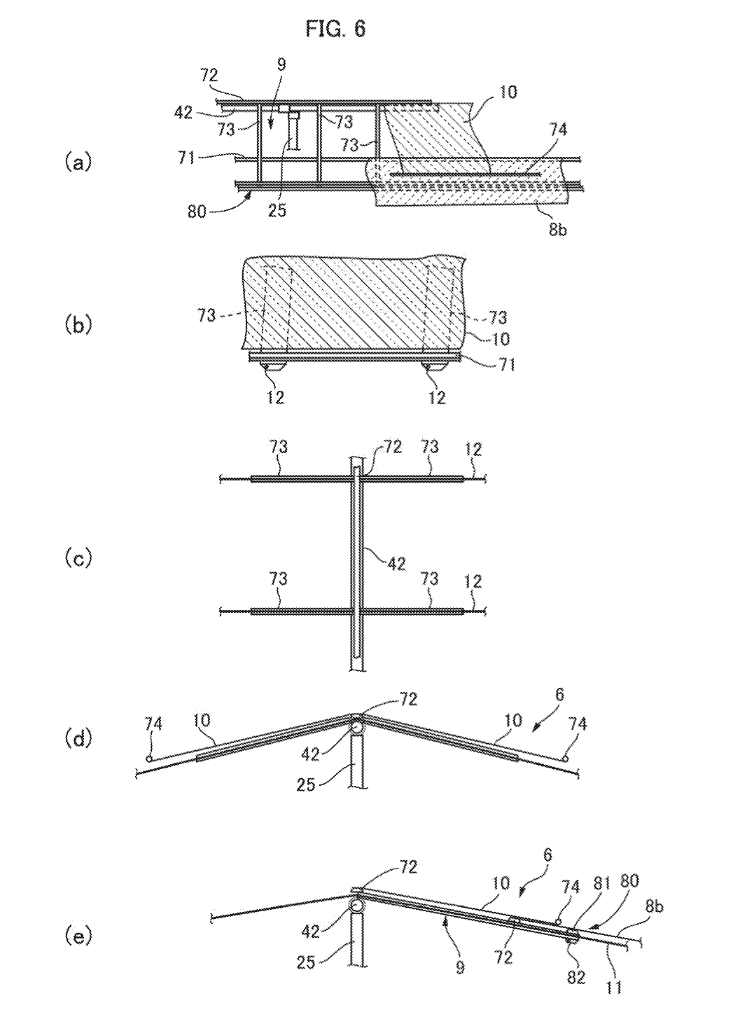

FIG. 6 shows descriptive drawings of the structure of the ceiling window portions disposed in the peak portion of the greenhouse building 2. Referring to these drawings, in the gable-style roof surface 6, longitudinally extending window frames 71 having groove cross-sections are disposed at positions separated by a predetermined width to the left and right from the peak. The window frames 71 are film stoppers, and the upper-end edge of the roof-surface translucent film 8b is inserted in and fixed to film-stopping grooves opening in the tops of the window frames. Between the ridge member 42 and the left and right window frames 71 are the ceiling windows 9, over which the roof-surface translucent film 8b is not pulled.

Attached to the ridge member 42 extending along the peak of the roof surface 6 is a peak film stopper 72 extending in the longitudinal direction along the ridge member 42. Between this peak film stopper 72 and film stoppers 80 positioned toward the troughs from the peak film stopper 71 in the roof surface 6, roller guides 73 extending in the crosswise direction are extended at fixed intervals. The film stoppers 80 are configured from upper film stoppers 81 and lower film stoppers 82.

Film-winding rollers 74 extending in the longitudinal direction are disposed on the roller guides 73, so as to be capable of rolling along the roller guides 73. The translucent ceiling window opening/closing films 10 are spread between the peak film stopper 72 and the film-winding rollers 74.

The film-winding rollers 74 can be rotated by winding operation handles 76 extending downward along the front and back gable-side wall frames 3F, 3B, as shown in FIG. 1. When the film-winding rollers 74 are rotated, the ceiling window opening/closing films 10 can be reeled in or unreeled, and the ceiling windows 9 can thereby be opened and closed. The mechanisms for reeling and unreeling the ceiling window opening/closing films are publicly known, and no further description is given.

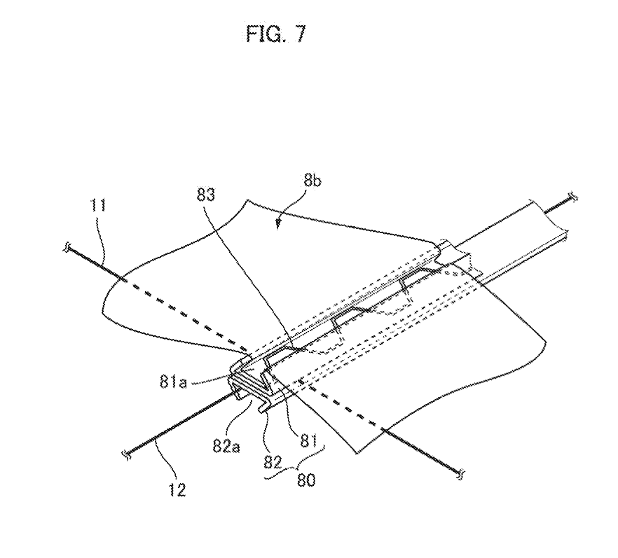

FIG. 7 shows a descriptive drawing of an attachment structure for the roof-surface translucent film 8b. Referring to FIGS. 1 and 7, the long roof-surface film stoppers 80 disposed along the tension wires 12 are disposed on the roof surface 6. The roof-surface film stoppers 80 each include an upper film stopper 81 and a lower film stopper 82, which have groove cross-sections, and which are combined back to back so as to open upward and downward. A tension wire 12 extends through the inside of a film-stopping groove 82a of the lower film stopper 82. A tension wire 11 passes between the upper film stopper 81 and the lower film stopper 82. The roof-surface translucent film 8b is disposed in a state of covering the upper side of the upper film stopper 81. Part of the roof-surface translucent film 8b is inserted from the upper side into a film-stopping groove 81a of the upper film stopper 81 and is fixed by a fixing spring member 83 so as to not come out of the film-stopping groove 81a.

The wall-surface translucent film 8a, which is affixed to the front and back gable-side walls and the left and right flat-side walls, is also fixed in place using film stoppers that have groove cross-sections and that are attached to the lateral members of these frames. The method of affixing this film, which uses film stoppers that are steel materials having this manner of groove cross-sections, is publicly known.

### Specific Example of Anchoring Tension Material

The following is a description of an example of anchoring tension materials suitable for use as the flat-side anchoring tension wires 17, 18 and the gable-side anchoring tension wires 15. The flat-side anchoring tension materials are described below, but it shall be apparent the gable-side anchoring tension materials can have a similar structure.

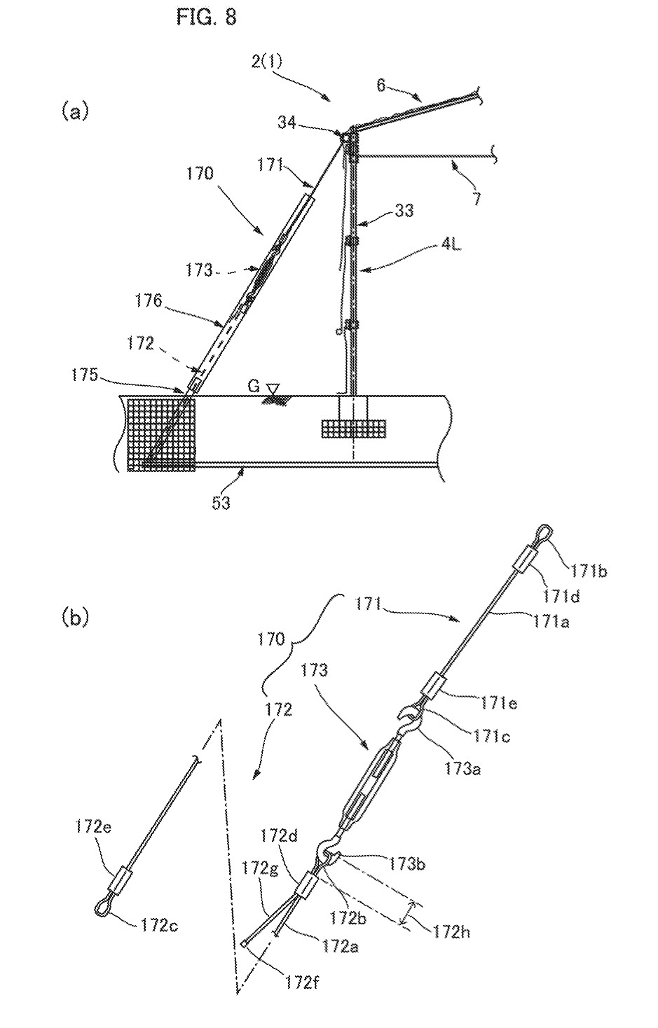

FIG. 8(a) shows a schematic side view of a flat-side anchoring tension material, and FIG. 8(b) shows a descriptive drawing of an upper tension wire thereof. This flat-side anchoring tension material 170 is configured from an upper wire 171, a lower pull-out wire 172, and a turnbuckle 173 extended therebetween.

The upper wire 171, which is made of stainless steel, includes a wire body 171a of a predetermined length, loops 171b, 171c formed at both ends of the wire body, and metal, cylindrical clips 171d, 171e for swaging, which cover the wire ends. The upper loop 171b is fastened to the upper end of the flat-side wall frame 4L, e.g., to a flat-side lateral member 34, and the lower loop 171c is fastened to an upper hook 173a of the turnbuckle 173.

The lower pull-out wire 172, which is made of stainless steel, includes a wire body 172a of a predetermined length, loops 172b, 172c formed at both ends of the wire body, and metal, cylindrical clips 172d, 172e for swaging. The upper loop 172b is fastened to a lower hook 173b of the turnbuckle 173. The lower loop 172c is fastened to an anchoring steel material 51 buried in the ground.

In the upper loop 172b of the lower pull-out wire 172, a wire end 172f is pulled out a predetermined length from a cylindrical clip 172d. A wire portion 172g, from the cylindrical clip 172d to the wire end 172f in the lower pull-out wire 172, functions as a wire length adjustment part. When the wire portion 172g is pushed toward the cylindrical clip 172d, a loop length 172h of the loop 172c increases, and the extended length of the lower pull-out wire 172 can be increased. After the extended length has been adjusted to an appropriate length, the cylindrical clip 172d is swaged.

The lower pull-out wire 172 is pulled out of the ground from the anchoring steel material 51 buried in the ground. The portion of the lower pull-out wire 172 buried in the ground is passed through and protected by a protective pipe 175 made of vinyl chloride or the like. The upper loop 171b of the upper wire 171 is fastened to the upper end of the flat-side wall frame 4L, and the turnbuckle 173 is extended between the lower loop 171c and the upper loop 172b of the lower pull-out wire 172 pulled out of the ground. The turnbuckle 173 is turned, and the flat-side anchoring tension material 170 is placed in a predetermined stretched state. The flat-side anchoring tension material 170 is covered by a protective pipe 176 made of vinyl chloride or the like.

There is variation in the lengths of the flat-side anchoring tension materials 170 installed on site. The extended lengths of the flat-side anchoring tension materials 170 can be set to the appropriate lengths by adjusting the loop lengths 172h of the upper loops 172b of the lower pull-out wires 172. Consequently, the necessary tension force can be imparted to the flat-side anchoring tension materials 170 by means of the turnbuckles 173. Tension adjustment members other than turnbuckles, e.g., latch-type wire winding mechanisms, can be used.

### Other Examples of Roof Surface

To affix the roof-surface translucent film 8b to the roof surface 6 in the buildings 2(1)-2(3) of the greenhouse building 1 described above, the roof-surface film stoppers 80, composed of long steel materials having groove cross-sections, are horizontally aligned in the longitudinal direction at predetermined intervals along the roof surface 6 (see FIG. 7). In the roof surface 6, the film-stopping grooves 81a in the horizontally disposed roof-surface film stoppers 80 open upward. There is a risk that rainwater accumulating in the film-stopping grooves 81a will flow to the back sides of the roof-surface film stoppers 80 and leak from the roof surface into the building. There is also a risk that water droplets adhering to the roof-surface film stoppers 80 will fall into the room. To avoid these problems, there are cases in which it is preferable to dispose the roof-surface film stoppers 80 in the crosswise direction, which runs along the roof slope.

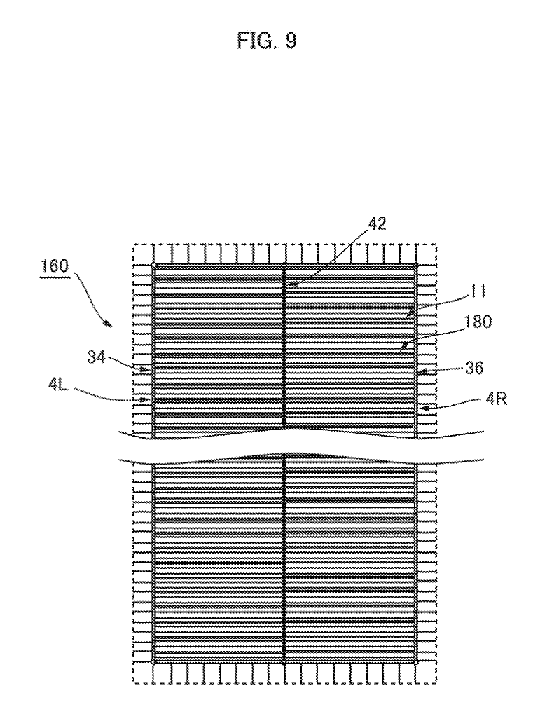

FIG. 9 shows a descriptive drawing of an example of the configuration of the roof surface 6 that is suitable for use in this case. The basic configuration of the roof surface 160 shown in this drawing is the same as that of the roof surface 6 described above; tension wires 11 extended at fixed intervals are provided at fixed intervals between the left and right flat-side wall frames 4L, 4R through the ridge member 42, and, though omitted from the drawing, horizontally extending tension wires 12 are provided at fixed intervals between the front and back gable-side wall frames 3F, 3B.

In the roof surface 160, one roof-surface film stopper 180 is aligned for every two of the tension wires 11 extending in the crosswise direction. In the drawing, the tension wires 11 are shown by thin lines, and the roof-surface film stoppers 180 are shown by thick lines. The left roof-surface film stoppers 180 are extended from the ridge member 42 to the flat-side lateral member 34 at the upper end of the left flat-side wall frame 4L, and the right roof-surface film stoppers 180 are extended from the ridge member 42 to the flat-side lateral member 36 of the right flat-side wall frame 4R.

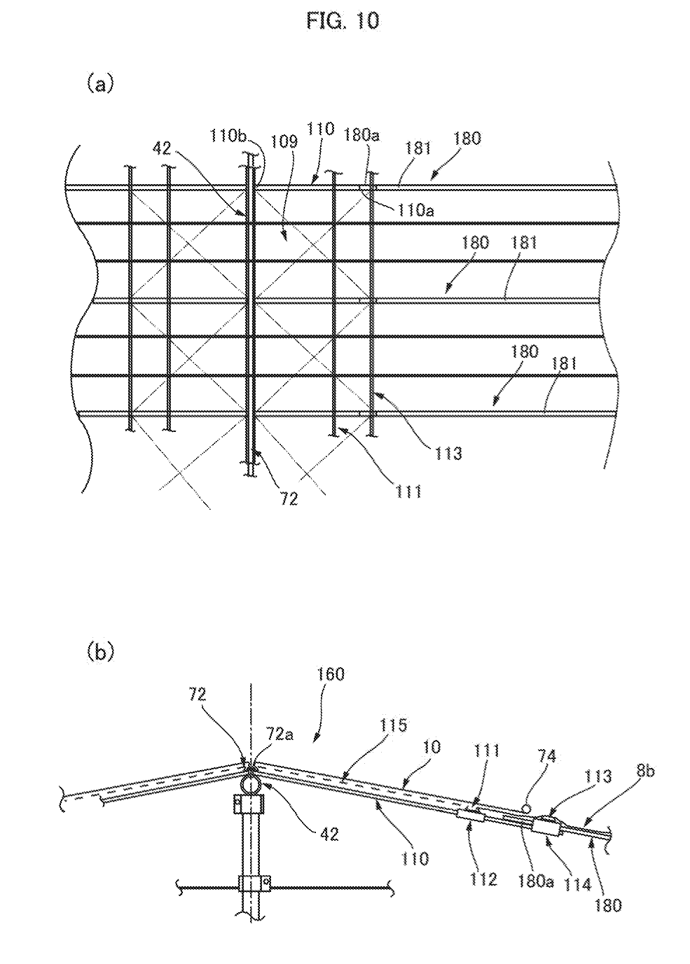

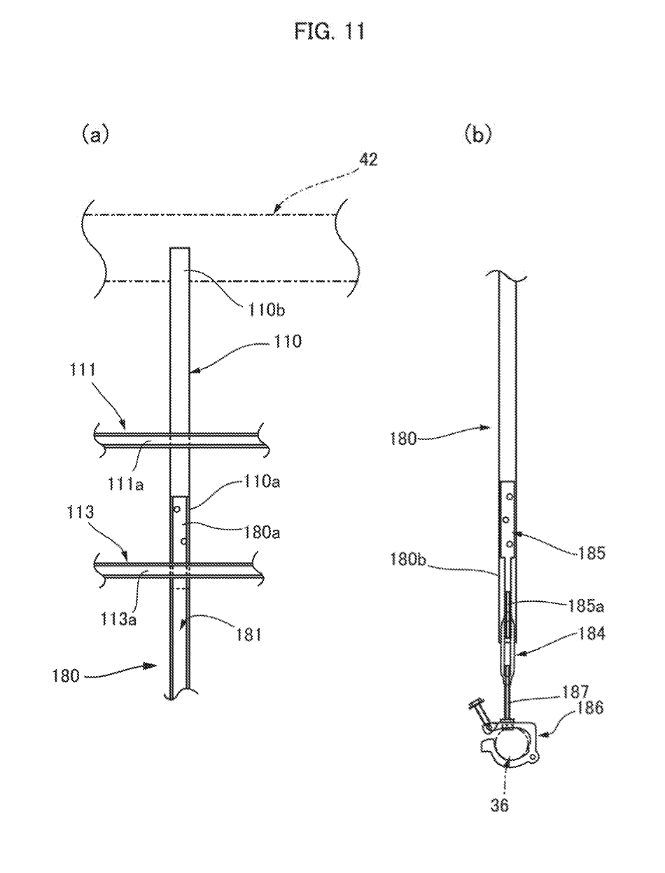

FIG. 10(a) shows a partial plan view of the state of alignment of the roof-surface film stoppers 180 in the peak portion of the roof surface 160, and FIG. 10(b) is a partial side view of the same. FIG. 11(a) shows a descriptive drawing of the upper end portion of a roof-surface film stopper 180, and FIG. 11(b) shows a descriptive drawing of the lower end portion of the same.

The roof-surface film stopper 180 is formed from a steel member having a groove cross-section, and a film-stopping groove 181 of the roof film stopper opens upward. An upper end 180a of the roof-surface film stopper 180 is linked to one end 110a of a window frame 110 of a ceiling window 109. The window frame 110 is formed from a steel member having a groove cross-section, and a film-stopping groove of this steel member opens downward. The other end 110b of the window frame 110 is linked to a ridge member 42 composed of a single pipe.

A lower end 180b of the roof-surface film stopper 180 is linked to the upper flat-side lateral member 36 of the flat-side wall frame 4R via a turnbuckle 184, which is a tension-imparting part, as shown in FIG. 11(b). FIG. 11(b) shows a descriptive drawing of a roof-surface film stopper 180 as seen from below. A linking plate 185 having a screw part is linked to the lower end 180b of the roof-surface film stopper 180, and the screw part 185a of the linking plate 185 is screwed into one end of the turnbuckle 184. A bolt 187 attached to a single-pipe clamp 186, which is attached to the flat-side lateral member 36, is screwed into the other end of the turnbuckle 184. A predetermined amount of tension is imparted to the roof-surface film stopper 180 by tightening the turnbuckle 184.

The ceiling window 109 is configured as follows. A window frame 111 composed of a steel material having a groove cross-section is extended over the window frame 110 in an orthogonal direction. The window frame 111 is fixed to the window frame 110 by a clamp 112, with a film-stopping groove 111a of the window frame facing upwards. Additionally, a window frame 113 composed of a steel material having a groove cross-section is extended in an orthogonal direction over the upper end 180a of the roof-surface film stopper 180. The window frame 113 is fixed to the upper end 180a by a clamp 114, with a film-stopping groove 113a of the window facing upwards.

The ceiling window 109 is a portion between the ridge member 42 and the window frame 111. An insect net 115 is stretched over the ceiling window 109. The insect net 115 is disposed from the peak film stopper 72 to the window frame 111. A ceiling window opening/closing film 10 is stretched over the insect net 115. One edge of the ceiling window opening/closing film 10 is inserted in and fixed to a film-stopping groove 72a of the peak film stopper 72. The other edge of the ceiling window opening/closing film 10 is wound over a film-winding roller 74.

The roof-surface translucent film 8b is affixed to a portion of the roof surface 160 extending from the window frame 111 to the flat-side wall frame 4L. The upper edge of the roof-surface translucent film 8b is inserted in and fixed to the film-stopping groove 111a of the window frame 111. Additionally, the portions on both sides of the roof-surface translucent film 8b are inserted in and fixed to the upward-facing film-stopping groove 181 of the roof-surface film stopper 180, which is aligned in a direction running along the roof slope. The necessary number of roof translucent films 8b of a predetermined width are laid over the roof surface, and the roof surface 160 is covered.

In the roof surface 160 of this configuration, the roof-surface film stoppers 180 are aligned from peak to trough along the roof slope. Rainwater or the like that has entered the upward-facing film-stopping grooves 181 of the roof-surface film stoppers 180 flows along the film-stopping grooves 181, down into the trough and into the gutter. Additionally, dew adhering to the roof-surface film stoppers 180 flows down into the trough through the inclined roof-surface film stoppers 180. Consequently, in this building, water droplets can be prevented from falling from the roof-surface film stoppers 180.

The roof-surface film stoppers 180 of the present example are extended between the ridge member 42 and the upper end of the flat-side wall frame 4R while under a predetermined amount of tension from tension-imparting parts composed of turnbuckles 184. Therefore, the roof-surface film stoppers 180, similar to the tension wires 11 constituting the roof surface 160, can also be made to function as roof-surface crosswise-directional tension members. Tension-imparting mechanisms other than turnbuckles can also be used.

### Other Embodiments

The greenhouse building of the present invention can be configured as a single-bay building rather than a multi-bay building. The greenhouse building can also have a multi-bay structure of four or more bays.

In the example described above, the intervals of longitudinal and crosswise alignment of tension wires, the intervals of gable-side support post and flat-side support post alignment, and the materials, sizes, etc., of tension wires, support posts, etc., constitute one example These factors can be set as appropriate in accordance with, inter alia, the size of the greenhouse building (the dimensions in the longitudinal and crosswise directions, the height of the ceiling, the height of the roof), and the environmental conditions of the location of installation.

1. A building having a tensile structure comprising:
front and back gable-side wall frames configured from gable-side support posts erected on an installation surface at predetermined intervals in a crosswise direction, rafters joining upper ends of the gable-side support posts together, and gable-side lateral members extended horizontally over the gable-side support posts;
left and right flat-side wall frames configured from flat-side support posts erected on the installation surface at predetermined intervals in a longitudinal direction, and flat-side lateral members extended horizontally between upper ends of the flat-side support posts;
a middle frame located between the left and right flat-side wall frames and configured from middle support posts erected on the installation surface at predetermined intervals in the longitudinal direction, and a ridge member extended horizontally over upper ends of the middle support posts;
a roof surface configured from roof-surface longitudinal-directional tension members spread in a taut state at predetermined intervals in the crosswise direction between upper ends of the front and back gable-side wall frames, and roof-surface crosswise-directional tension members spread in a taut state through the ridge member at predetermined intervals in the longitudinal direction between upper ends of the left and right flat-side wall frames;
a ceiling surface configured from ceiling-surface longitudinal-directional tension members spread in a taut state at predetermined intervals in the crosswise direction between the upper ends of the front and back gable-side wall frames, and ceiling-surface crosswise-directional tension members spread in a taut state at predetermined intervals in the longitudinal direction between the upper ends of the left and right flat-side wall frames;
gable-side anchoring tension members spread in a taut state at predetermined intervals in the crosswise direction between the installation surface and the upper ends of the front and back gable-side wall frames; and
flat-side anchoring tension members spread in a taut state at predetermined intervals in the longitudinal direction between the installation surface and the upper ends of the left and right flat-side wall frames.

2. The building having the tensile structure according to claim 1,
wherein at least either one of the flat-side anchoring tension member and the gable-side anchoring tension member has an upper wire, a lower pull-out wire pulled out from the installation surface, and a tension adjustment member extended between the upper wire and the lower pull-out wire, and
at least either one of the upper wire and the lower pull-out wire has an adjustment part capable of adjusting an extending length of wire.

3. The building having the tension structure according to claim 1, further comprising:
a translucent panel or a translucent film that is affixed to at least one of the gable-side wall frames, the flat-side wall frames, and the roof surface.

4. The building having the tension structure according to claim 1, further comprising:
film stoppers that are extended in the longitudinal direction or the crosswise direction and are disposed at predetermined intervals along the roof surface; and
a translucent film that is affixed to the roof surface so as to cover the film stoppers from above,
wherein each of the film stoppers is provided with an upward-opening film-stopping groove extending in a length direction thereof, and
parts of the translucent film are inserted into the film-stopping grooves from above and fixed so as to not come out of the film-stopping grooves.

5. The building having the tension structure according to claim 1, further comprising:
film stoppers that are extended in the crosswise direction between the ridge member and the upper ends of the gable-side wall frames at predetermined intervals along the roof surface;
tension-imparting members that impart a predetermined amount of tension to the film stoppers; and
a flexible translucent film that is disposed on the roof surface so as to cover the film stoppers from above,
wherein each of the film stoppers is provided with an upward-opening film-stopping groove extending in a length direction thereof, and
parts of the translucent film are inserted into the film-stopping grooves from above and fixed so as to not come out of the film-stopping grooves.

6. The building having the tension structure according to claim 1, further comprising:
film stoppers that are extended in the longitudinal direction and are spread between the rafters of the front and back gable-side wall frames at predetermined intervals; and
a translucent film that is disposed on the roof surface so as to cover the film stoppers from above,
wherein each of the film stoppers has an upper film stopper having an upward-opening groove cross-section and a lower film stopper having a downward-opening groove cross-section,
the roof-surface longitudinal-directional tension members are disposed in the film-stopping grooves of the lower film stoppers,
the roof-surface crosswise-directional tension members are disposed between the upper film stoppers and the lower film stoppers, and
parts of the translucent film are inserted in from above and fixed to the film-stopping groove in the upper film stoppers so as to not come out of the film-stopping grooves.

7. The building having the tension structure according to claim 1,
wherein a roof-surface translucent film is affixed to the roof surface,
a window frame having a groove cross-section is disposed along the roof-surface longitudinal-directional tension members, the window frame being at a position separated by a prescribed distance from the ridge member of the roof surface in the crosswise direction,
a ceiling window is formed between the ridge member and the window frame where the roof-surface translucent film is not pulled,
a peak film stopper that has a groove cross-section and extends in the longitudinal direction along the ridge member is attached to the ridge member,
a roller guide disposed along the roof-surface longitudinal-directional tension members is extended between the peak film stopper and the widow frame,
a winding roller extending in the longitudinal direction is disposed on the roller guide in a state of capable of rolling along the roller guide, and
a translucent ceiling window opening/closing film is spread between the peak film stopper and the winding roller.

8. A multi-bay building comprising:
at least first and second buildings conjoined in a crosswise direction, wherein both the first building and the second building are the building as set forth in claim 1, and
the flat-side wall frame positioned between the first building and the second building is a single shared flat-side wall frame.

9. The multi-bay building according to claim 8,
wherein a gutter is disposed in a trough portion formed between the roof surfaces of the first and second buildings, the gutter having a predetermined drainage slope outward in the longitudinal direction from a middle of the longitudinal direction.

10. A multi-bay building comprising:
at least first and second buildings conjoined in a crosswise direction,
wherein both the first building and the second building are the building as set forth in claim 2, and
the flat-side wall frame positioned between the first building and the second building is a single shared flat-side wall frame.

11. A multi-bay building comprising:
at least first and second buildings conjoined in a crosswise direction,
wherein both the first building and the second building are the building as set forth in claim 3, and
the flat-side wall frame positioned between the first building and the second building is a single shared flat-side wall frame.

12. A multi-bay building comprising:
at least first and second buildings conjoined in a crosswise direction,
wherein both the first building and the second building are the building as set forth in claim 4, and
the flat-side wall frame positioned between the first building and the second building is a single shared flat-side wall frame.

13. A multi-bay building comprising:
at least first and second buildings conjoined in a crosswise direction,
wherein both the first building and the second building are the building as set forth in claim 5, and
the flat-side wall frame positioned between the first building and the second building is a single shared flat-side wall frame.

14. A multi-bay building comprising:
at least first and second buildings conjoined in a crosswise direction,
wherein both the first building and the second building are the building as set forth in claim 6, and
the flat-side wall frame positioned between the first building and the second building is a single shared flat-side wall frame.

15. A multi-bay building comprising:
at least first and second buildings conjoined in a crosswise direction,
wherein both the first building and the second building are the building as set forth in claim 7, and
the flat-side wall frame positioned between the first building and the second building is a single shared flat-side wall frame.
